(19) United States
(12) Patent Application Publication
(10) Pub. No.: US 2025/0282374 A1
(43) Pub. Date: Sep. 11, 2025

(54) CONTROL DEVICE, AND CONTROL METHOD

(71) Applicant: HONDA MOTOR CO., LTD., Minato-ku, Tokyo (JP)

(72) Inventor: Tomotaka Teramachi, Wako-shi (JP)

(21) Appl. No.: 19/059,738

(22) Filed: Feb. 21, 2025

(30) Foreign Application Priority Data
Mar. 7, 2024 (JP) 2024-034916

(51) Int. Cl. B60W 50/14; B60W 30/18; G06V 20/58

(52) U.S. Cl. CPC B60W 50/14; B60W 30/18163; G06V 20/58; B60W 2050/143; B60W 2050/146; B60W 2420/403; B60W 2554/4041

(57) ABSTRACT

A control device performs: outputting a first alarm when it is estimated that a mobile object is to move to a second lane which is adjacent to a first lane; starting automatic lane change control; automatically changing the lane of the mobile object to the second lane when it is determined that the lane change is possible; and outputting a second alarm for notifying an occupant that the mobile object is not able to automatically change the lane to the second lane when it is determined that the lane change is not possible. The control device curbs outputting of the other alarm when one alarm of the first alarm and the second alarm is output and a condition in which the other alarm is to be output is satisfied.

### CROSS-REFERENCE TO RELATED APPLICATION

Priority is claimed on Japanese Patent Application No. 2024-034916, filed Mar. 7, 2024, the content of which is incorporated herein by reference.

### BACKGROUND

### Field of the Invention

The present invention relates to a control device, and a control method.

### Description of Related Art

Recently, measures for providing a sustainable transportation system in consideration of various situations have been actively realized. Focus has been put on research and development for further improving safety or convenience of traffic through research and development for driving support technology toward such realization. For example, a blind-spot approaching object alarm device that curbs outputting of an alarm even if a driver detects another vehicle approaching a host vehicle in a predetermined range on the rear side of an adjacent lane to which the host vehicle is to perform lane change when it is estimated that the driver recognizes a road situation on the rear side of the adjacent lane while the road is in a traffic jam and the driver operates a turn signal for lane change has been disclosed (for example, Japanese Unexamined Patent Application, First Publication No. 2015-132966).

### SUMMARY

In the related art, a relationship between functions of outputting different alarms is not considered. Accordingly, alarms may not be suitable for an occupant (for example, a driver) of a mobile object. For example, an occupant of a mobile object may feel inconvenience from alarms.

The present invention was made in consideration of the aforementioned circumstances, and an objective thereof is to provide a control device, and a control method that can output an alarm appropriate for an occupant (for example, a driver) of a mobile object. For example, it is possible to curb inconvenience to an occupant of a mobile object. Another objective thereof is to further contribute to development of a sustainable transportation system.

A control device, a control method, and a storage medium according to the present invention employ the following configurations.
(1) According to an aspect of the present invention, a control device is provided, including: a storage medium storing computer-readable instructions; and one or more processors connected to the storage medium, wherein the one or more processors execute the computer-readable instructions to perform: recognizing an object which is present in a second lane adjacent to a first lane in which a mobile object is traveling and which is present near the mobile object; outputting a first alarm when it is estimated that the mobile object is to move to the second lane in which the object is present in response to an operation performed by an occupant of the mobile object; starting automatic lane change control for automatically changing a lane of the mobile object to the second lane in which the object is present in response to an operation performed by an occupant of the mobile object; automatically changing the lane of the mobile object to the second lane when it is determined that the lane change is possible; outputting a second alarm for notifying the occupant that the mobile object is not able to automatically change the lane to the second lane when it is determined that the lane change is not possible; and curbing outputting of the other alarm when one alarm of the first alarm and the second alarm is output and a condition in which the other alarm is to be output is satisfied.
(2) In the aspect of (1), the one or more processors execute the computer-readable instructions to perform curbing outputting of the other alarm when the one alarm is output for a first object which is the object and a condition in which the other alarm for the first object is to be output is satisfied.
(3) In the aspect of (1), the one or more processors execute the computer-readable instructions to perform not curbing the other alarm when the one alarm is output for a first object which is the object and a condition in which the other alarm for a second object other than the first object is to be output is satisfied.
(4) In the aspect of (1), the first alarm is output when the occupant has performed an operation, and the second alarm is output when it is determined that the automatic lane change is not possible when a predetermined time elapses after the occupant has performed the operation.
(5) In the aspect of (1), the one or more processors execute the computer-readable instructions to perform: outputting the first alarm in response to an operation performed by the occupant; starting the automatic lane change control for automatically changing the lane of the mobile object to the second lane in which the object is present; and curbing outputting of the second alarm when it is determined that the lane change is not possible and then outputting the second alarm again when the automatic lane change control is started in response to an operation performed by the occupant.
(6) In the aspect of (1), the one or more processors execute the computer-readable instructions to perform outputting the other alarm when a condition in which the other alarm other than the one alarm is to be output is satisfied when a predetermined time elapses or the mobile object moves by a predetermined distance after the one of the first alarm and the second alarm has been output.
(7) In the aspect of (1), operations which are performed by the occupant of the mobile object and which serve as a trigger of the first alarm and the second alarm are operations on the same operator.
(8) In the aspect of (1), the operator is an operator for turning on a turn signal.
(9) In the aspect of (1), the first alarm is an alarm for notifying of the presence of another mobile object which is present in a blind spot on a lateral side of the mobile object which the occupant of the mobile object has difficulty in seeing when the other mobile object is present in the blind spot and the occupant turns on a turn signal such that the lane is changed to a lane in which the other mobile object is traveling.
(10) According to another aspect of the present invention, a control device is provided, including: a storage medium storing computer-readable instructions; and one or more processors connected to the storage medium, wherein the one or more processors execute the computer-readable instructions to perform: recognizing an object which is present in a second lane adjacent to a first lane in which a mobile object is traveling and which is present near the mobile object; outputting a first alarm when it is estimated that the mobile object is to move to the second lane in which the object is present in response to a first operation performed on an operator by an occupant of the mobile object; starting automatic lane change control for automatically changing a lane of the mobile object to the second lane in which the object is present in response to a second operation performed on the operator by an occupant of the mobile object; automatically changing the lane of the mobile object to the second lane when it is determined that the lane change is possible; outputting a second alarm for notifying the occupant that the mobile object is not able to automatically change the lane to the second lane when it is determined that the lane change is not possible; and outputting the first alarm in response to the first operation when the first operation is performed and the second operation is performed successive to the first operation and curbing outputting of the second alarm when it is determined that the lane change is not possible in response to the second operation performed successive to the first operation.
(11) According to another aspect of the present invention, a control method is provided that is performed by a computer, the control method including: recognizing an object which is present in a second lane adjacent to a first lane in which a mobile object is traveling and which is present near the mobile object; outputting a first alarm when it is estimated that the mobile object is to move to the second lane in which the object is present in response to an operation performed by an occupant of the mobile object; starting automatic lane change control for automatically changing a lane of the mobile object to the second lane in which the object is present in response to an operation performed by an occupant of the mobile object; automatically changing the lane of the mobile object to the second lane when it is determined that the lane change is possible; outputting a second alarm for notifying the occupant that the mobile object is not able to automatically change the lane to the second lane when it is determined that the lane change is not possible; and curbing outputting of the other alarm when one alarm of the first alarm and the second alarm is output and a condition in which the other alarm is to be output is satisfied.
(12) According to another aspect of the present invention, a storage medium storing a program is provided, the program causing a computer to perform: a process of recognizing an object which is present in a second lane adjacent to a first lane in which a mobile object is traveling and which is present near the mobile object; a process of outputting a first alarm when it is estimated that the mobile object is to move to the second lane in which the object is present in response to an operation performed by an occupant of the mobile object; a process of starting automatic lane change control for automatically changing a lane of the mobile object to the second lane in which the object is present in response to an operation performed by an occupant of the mobile object; a process of automatically changing the lane of the mobile object to the second lane when it is determined that the lane change is possible; a process of outputting a second alarm for notifying the occupant that the mobile object is not able to automatically change the lane to the second lane when it is determined that the lane change is not possible; and a process of curbing outputting of the other alarm when one alarm of the first alarm and the second alarm is output and a condition in which the other alarm is to be output is satisfied.

According to the aspects of (1) to (12), it is possible to output an alarm appropriate for an occupant (for example, a driver) of a mobile object. For example, it is possible to curb inconvenience to an occupant of a mobile object.

According to the aspect of (2), since outputting of alarms about the same object can be curbed, it is possible to curb inconvenience to an occupant of a mobile object.

According to the aspect of (3), since alarms about different objects are output, an occupant of a mobile object can recognize different objects.

According to the aspect of (4), even when determination for lane change is performed in a predetermined time after an operation, it is possible to curb outputting of a second alarm and to curb inconvenience to an occupant of a mobile object.

According to the aspect of (5), when a driver of a mobile object has performed a lane changing operation a plurality of times, the driver is not highly likely to recognize an object, and thus a second alarm is output. Accordingly, it is possible to allow the driver of the mobile object to more reliably recognize different objects.

According to the aspect of (6), it is possible to allow the driver of the mobile object to more reliably recognize an object.

According to the aspect of (7), it is possible to curb outputting of a second alarm when different functions are performed by the same operator.

### BRIEF DESCRIPTION OF THE DRAWINGS

FIG. 1 is a diagram showing a configuration of a vehicle system employing a vehicle control system according to an embodiment.

FIG. 2 is a diagram showing a first process of a first controller.

FIG. 3 is a diagram showing a second process of a second controller.

FIG. 4 is a timing chart showing the second process.

FIG. 5 is a diagram showing processes in a comparative example and the embodiment.

FIG. 6 is a diagram showing a timing chart of a process in a comparative example and a timing chart of a process in the embodiment.

FIG. 7 is a flowchart showing an example of a process flow that is performed by the first controller.

FIG. 8 is a flowchart showing an example of a process flow that is performed by the first controller.

FIG. 9 is a diagram showing an example of reference information.

FIG. 10 is a diagram showing a situation in which outputting of a second alarm is curbed.

### DETAILED DESCRIPTION OF THE INVENTION

### Entire Configuration

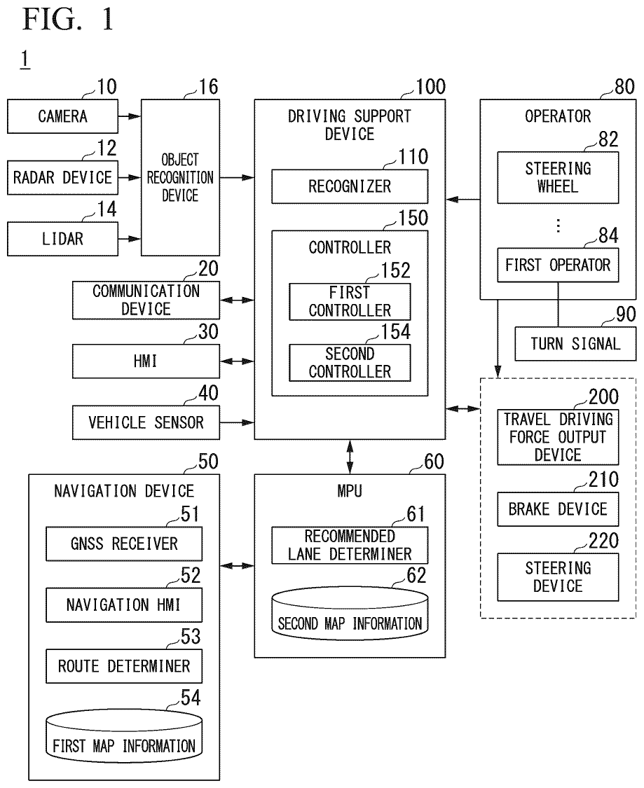

FIG. 1 is a diagram showing a configuration of a vehicle system 1 employing a vehicle control system according to an embodiment. A vehicle in which the vehicle system 1 is mounted is, for example, a vehicle with two wheels, three wheels, or four wheels, and a drive source thereof is an internal combustion engine such as a diesel engine or a gasoline engine, an electric motor, or a combination thereof. The electric motor operates using electric power generated by a power generator connected to the internal combustion engine or using electric power discharged from a secondary battery or a fuel cell. It is assumed that the present embodiment is applied to a vehicle, but the present embodiment may be applied to a mobile object other than a vehicle.

The vehicle system 1 includes, for example, a camera 10, a radar device 12, a Light Detection and Ranging (LIDAR) device 14, an object recognition device 16, a communication device 20, a human-machine interface (HMI) 30, a vehicle sensor 40, a navigation device 50, an MPU 60, an operator 80, a turn signal 90, a driving support device 100, a travel driving force output device 200, a brake device 210, and a steering device 220. These devices or instruments are connected to each other via a multiplex communication line such as a controller area network (CAN) communication line, a serial communication line, a radio communication network, or the like. The configuration shown in FIG. 1 is only an example, and part of the configuration may be omitted or another configuration may be added thereto. The driving support device 100 is an example of a “vehicle control device.”

The camera 10 is, for example, a digital camera using a solid-state imaging device such as a charge-coupled device (CCD) or a complementary metal-oxide-semiconductor (CMOS). The camera 10 is attached to an arbitrary position on a vehicle in which the vehicle system 1 is mounted (hereinafter referred to as a vehicle M). When a forward view is imaged, the camera 10 is attached to an upper part of a front windshield, a rear surface of a rearview mirror, or the like. The camera 10 images the surroundings of the vehicle M, for example, periodically and repeatedly. The camera 10 may be a stereo camera.

The radar device 12 radiates radio waves such as millimeter waves to the surroundings of the vehicle M, detects radio waves (reflected waves) reflected by an object, and detects at least a position (a distance and a direction) of the object. The radar device 12 is attached to an arbitrary position on the vehicle M. The radar device 12 may detect a position and a speed of an object using a frequency-modulated continuous wave (FM-CW) method.

The LIDAR device 14 radiates light (or electromagnetic waves of wavelengths close to light) to the surroundings of the vehicle M and measures scattered light. The LIDAR device 14 detects a distance to an object on the basis of a time from radiation of light to reception of light. The radiated light is, for example, a pulse-like laser beam. The LIDAR device 14 is attached to an arbitrary position on the vehicle M.

The object recognition device 16 performs a sensor fusion process on results of detection from some or all of the camera 10, the radar device 12, and the LIDAR device 14 and recognizes a position, a type, a speed, and the like of an object. The object recognition device 16 outputs the result of recognition to the driving support device 100. The object recognition device 16 may output the results of detection from the camera 10, the radar device 12, and the LIDAR device 14 to the driving support device 100 without any change. The object recognition device 16 may be omitted from the vehicle system 1.

The communication device 20 communicates with other vehicles near the vehicle M, for example, using a cellular network, a Wi-Fi network, Bluetooth (registered trademark), or dedicated short-range communication (DSRC) or communicates with various server devices via radio base stations.

The HMI 30 presents various types of information to an occupant of the vehicle M and receives an input operation from the occupant. The HMI 30 includes various display devices, a speaker, buzzers, a touch panel, switches, and keys. The HMI 30 includes a display device. The display device is, for example, a display device, that is, a multi-information display, that is provided at the center of an instrument panel of the vehicle M and displays various types of information on the vehicle M such as a speed meter (a speedometer) showing a traveling speed of the vehicle M or a revolution counter (a tachometer) showing the number of revolutions (a rotation speed) of the internal combustion engine provided in the vehicle M.

The vehicle sensor 40 includes a vehicle speed sensor that detects a speed of the vehicle M, an acceleration sensor that detects acceleration, a yaw rate sensor that detects an angular velocity around a vertical axis, and a direction sensor that detects a direction of the vehicle M.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the vehicle M on the basis of signals received from GNSS satellites. The position of the vehicle M may be identified or corrected by an inertial navigation system (INS) using the output of the vehicle sensor 40. The navigation HMI 52 includes a display device, a speaker, a touch panel, and keys. The navigation HMI 52 may be partially or wholly shared by the HMI 30. For example, the route determiner 53 determines a route (hereinafter referred to as a route on a map) from the position of the vehicle M identified by the GNSS receiver 51 (or an input arbitrary position) to a destination input by an occupant using the navigation HMI 52 with reference to the first map information 54. The first map information 54 is, for example, information in which a road shape is expressed by links indicating a road and nodes connected by the links. The first map information 54 may include a curvature of a road and point of interest (POI) information. The route on a map is output to the MPU 60. The navigation device 50 may perform route guidance using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and acquire a route which is equivalent to the route on a map from the navigation server.

The MPU 60 includes, for example, a recommended lane determiner 61 and stores second map information 62 in a storage device such as an HDD or a flash memory. The recommended lane determiner 61 divides a route on a map provided from the navigation device 50 into a plurality of blocks (for example, every 100 [m] in a vehicle traveling direction) and determines a recommended lane for each block with reference to the second map information 62. The recommended lane determiner 61 determines in which lane from the leftmost the vehicle is to travel. When there is a branching point in the route on a map, the recommended lane determiner 61 determines the recommended lane such that the vehicle M can travel along a rational route for traveling to a branching destination. For example, when the vehicle M arrives at a position in a predetermined distance before a branch lane, the recommended lane determiner 61 determines a lane connected to the branch lane as a recommended lane. The recommended lane determiner 61 and the second map information 62 may be a functional unit and information included in another device such as the driving support device 100.

The second map information 62 is map information with higher precision than the first map information 54. For example, the second map information 62 may include information of centers of lanes and information of boundaries of lanes. The second map information 62 may include road information, traffic regulation information, address information (addresses and postal codes), facility information, and phone number information. The second map information 62 may be updated from time to time by causing the communication device 20 to communicate with another device.

The operator 80 includes, for example, an accelerator pedal, a brake pedal, a shift lever, and other operators in addition to a steering wheel 82. A sensor that detects an amount of operation or performing of an operation is attached to the operator 80. A result of detection of the sensor is output to the driving support device 100 or output to some or all of the travel driving force output device 200, the brake device 210, and the steering device 220. The steering wheel 82 does not have to have a ring shape and may have a shape of a deformed steering wheel, a joystick, a button, or the like. The operator 80 includes a first operator 84. The turn signal 90 is turned on or turned off according to an operation of the first operator 84.

The first operator 84 is, for example, a turn signal lever switch. For example, when a driver operates the first operator 84, the turn signal 90 is turned on in response to the operation. When the driver performs a predetermined operation on the first operator 84, a controller 150 starts an auto lane change (ALC) function and causes the vehicle M to perform automatic lane change (auto lane change). The predetermined operation is an operation serving as a trigger for starting the ALC function. The predetermined operation is, for example, an operation of operating the turn signal lever switch in a direction in which a lane is to be changed or an operation of pressing the turn signal lever switch to a predetermined position. More specifically, the predetermined operation is an operation of operating the turn signal lever switch in a state in which a predetermined position is maintained in a direction in which a lane is to be changed for a predetermined time.

The driving support device 100 includes, for example, a recognizer 110 and the controller 150. The recognizer 110 and the controller 150 are realized, for example, by causing a hardware processor such as a central processing unit (CPU) to execute a program (software). Some or all of these constituents may be realized by hardware (a circuit part including circuitry) such as a large-scale integration (LSI) device, an application-specific integrated circuit (ASIC), or a field-programmable gate array (FPGA), a graphics-processing unit (GPU), or a system on chip (SOC) or may be cooperatively realized by software and hardware. The program may be stored in a storage device (a storage device including a non-transitory storage medium) such as an HDD or a flash memory of the driving support device 100 in advance, or may be stored in a removable storage medium such as a DVD or a CD-ROM and installed in the HDD or the flash memory of the driving support device 100 by setting the removable storage medium (a non-transitory storage medium) into a drive device.

The recognizer 110 recognizes states such as a position, a speed, and an acceleration of an object near the vehicle M on the basis of information input from the camera 10, the radar device 12, and the LIDAR device 14 via the object recognition device 16. For example, a position of an object is recognized as a position in an absolute coordinate system with an origin set to a representative point (such as the center of gravity or the center of a drive shaft) of the vehicle M and is used for control. A position of an object may be expressed as a representative point such as the center of gravity or a corner of the object or may be expressed as an area. A “state” of an object may include an acceleration or a jerk of the object or a “moving state” (for example, whether lane change is being performed or whether lane change is going to be performed) of the object.

The recognizer 110 recognizes, for example, a lane (a traveling lane) in which the vehicle M is traveling. For example, the recognizer 110 recognizes the traveling lane through comparison between a pattern of road markings (for example, arrangement of a solid line and a dotted line) obtained from the second map information 62 and a pattern of road markings near the vehicle M recognized from an image captured by the camera 10. The recognizer 110 is not limited to the road markings, but may recognize the traveling lane by recognizing a road marking or traveling lane boundaries (road boundaries) including roadsides, curbstones, median strips, guard rails, and the like. In this recognition, the position of the vehicle M acquired from the navigation device 50 or the result of processing from the INS may be considered. The recognizer 110 recognizes a stop line, an obstacle, a red signal, a toll gate, or other road events.

The recognizer 110 recognizes a position or a direction of the vehicle M with respect to a traveling lane at the time of recognition of the traveling lane. The recognizer 110 may recognize, for example, a separation of a reference point of the vehicle M from the lane center and an angle of the traveling direction of the vehicle M with respect to a line formed by connecting the lane centers as the position and the direction of the vehicle M with respect to the traveling lane. Instead, the recognizer 110 may recognize a position of a reference point of the vehicle M with respect to one side line of the traveling lane (a road marking or a road boundary) or the like as the relative position of the vehicle M with respect to the traveling lane.

The controller 150 performs driving support control. For example, the controller 150 automatically controls the travel driving force output device 200 and the brake device 210 regardless of the driver's operation such that the speed of the vehicle M is automatically controlled. The controller 150 performs so-called adaptive cruise control (ACC).

The controller 150 controls the steering device 220 such that the vehicle M does not depart from (leave) a traveling lane. For example, the controller 150 controls the steering device 220 such that the vehicle M travels at the center of the traveling lane recognized by the recognizer 110 or in the vicinity of the center. In the following description, this control may be referred to as “lane keeping control.” The controller 150 performs hands-on lane keeping control and hands-off lane keeping control.

Hands-on lane keeping control is control that is performed in a state in which a driver grasps the steering wheel (a state in which grasping of the steering wheel is detected by a steering grasp sensor which is not shown). Conditions in which hands-on lane keeping control is executable are less strict than conditions in which hands-off lane keeping control is executable.

Hands-off lane keeping control is control that is performed in a state in which a driver does not grasp the steering wheel (a state in which grasping of the steering wheel is not detected by a steering grasp sensor which is not shown). Hands-off lane keeping control is executable, for example, when the following conditions are satisfied. The conditions include a condition in which a speed of the vehicle M is equal to or higher than a predetermined speed, a condition in which the vehicle M is traveling on a predetermined road (for example, a road or road type which is set to allow hands-off lane keeping control in advance), and a condition in which a driver monitors the forward view. Hands-off lane keeping control is performed when a driver monitors a forward view, and hands-off lane keeping control is not performed or is stopped when a driver does not monitor a forward view.

The aforementioned conditions in which hands-on lane keeping control and hands-off lane keeping control are executable are only examples, and another condition (for example, a condition in which the vehicle M follows a preceding vehicle) may be added or some conditions may be omitted. Conditions in which hands-on lane keeping control is executable have only to be less strict than conditions in which hands-off lane keeping control is executable (conditions in which hands-off lane keeping control is executable have only to be stricter than conditions in which hands-on lane keeping control is executable). Whether a driver monitors a forward view is recognized by the driving support device 100 on the basis of an image captured by a camera (not shown) for imaging a driver. The controller 150 includes a first controller 152 and a second controller 154. Details thereof will be described later.

The travel driving force output device 200 outputs a travel driving force (a torque) for allowing the vehicle M to travel to driving wheels. The travel driving force output device 200 includes, for example, a combination of an internal combustion engine, an electric motor, and a transmission, and an electronic control unit (ECU) that controls them. The ECU controls the aforementioned constituents on the basis of information input from the driving support device 100 or information input from the operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the driving support device 100 or the information input from the operator 80 such that a brake torque based on a braking operation is output to vehicle wheels.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the driving support device 100 or the information input from the operator 80 and changes the direction of the turning wheels.

### First Process of First Controller

The first controller 152 outputs a first alarm when it is estimated that the vehicle M is to move to a second lane which is adjacent to a first lane in which the vehicle M is traveling and in which an object is present in response to an operation performed by an occupant of the vehicle M. The first controller 152 realizes a so-called blind spot information function. The first alarm is an alarm for notifying of the presence of another vehicle which is present in a blind spot on a lateral side of the vehicle M which the occupant of the vehicle M has difficulty seeing when the other vehicle is present in the blind spot and the occupant turns on a turn signal such that the vehicle M is to change the lane to the lane in which the other vehicle is traveling. Outputting of the first alarm is an operation which is performed when an operation (for example, an operation of turning on the turn signal 90) is performed by the occupant.

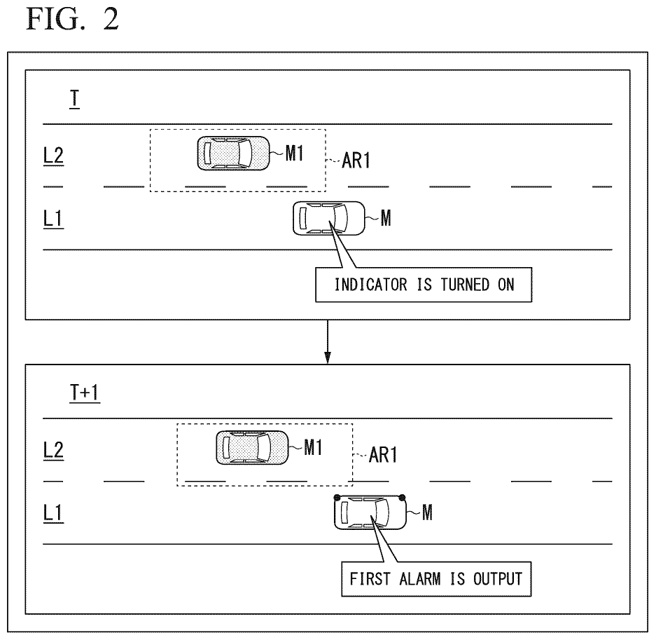

FIG. 2 is a diagram showing a first process of the first controller 152. At time T, the vehicle M is traveling in a first lane L1 and a vehicle M1 is traveling in a second lane. The first controller 152 notifies a driver that the vehicle M1 is present when the vehicle M1 is present in a first area ARI on the basis of the recognition result of the recognizer 110. This notification is, for example, notification which is performed by turning on a predetermined indicator provided in the vehicle M. The first area AR1 is, for example, an area which the driver has difficulty in seeing such as a lateral rear side or a lateral side of the vehicle M in the second lane L2 or an area which is not reflected well in a door mirror of the vehicle M.

At time T+1, when the driver operates the first operator 84 to turn on the turn signal 90, the first controller 152 outputs a first alarm. The first alarm is, for example, Outputting of the first alarm may be performed using an image, blinking the indicator.

speech, or the like or may be performed by causing a safety belt, a steering wheel, or the like to vibrate. It is “estimated that the vehicle M moves to the second lane” on the basis of the driver's operation of turning on the turn signal 90 (an operation of turning on the turn signal 90 to a lane toward which lane change is to be performed). In this way, the first controller 152 can notify the driver of the vehicle M of the presence of the vehicle M1 which is present in the first area ARI which the driver has difficulty in seeing.

### Second Process of Second Controller

The controller 150 automatically changes the lane of the vehicle M. Control for automatically changing the lane may be performed on the basis of the premise that hands-off lane keeping control is performed or hands-on lane keeping control is performed.

The second controller 154 starts automatic lane change control for automatically changing the lane of the vehicle M to the second lane in response to an operation performed by an occupant and automatically changes the lane of the vehicle M to the second lane when it is determined that lane change is possible. When it is determined that lane change is not possible, the second controller 154 outputs a second alarm for notifying the occupant that automatic change of the lane of the vehicle M to the second lane is not possible.

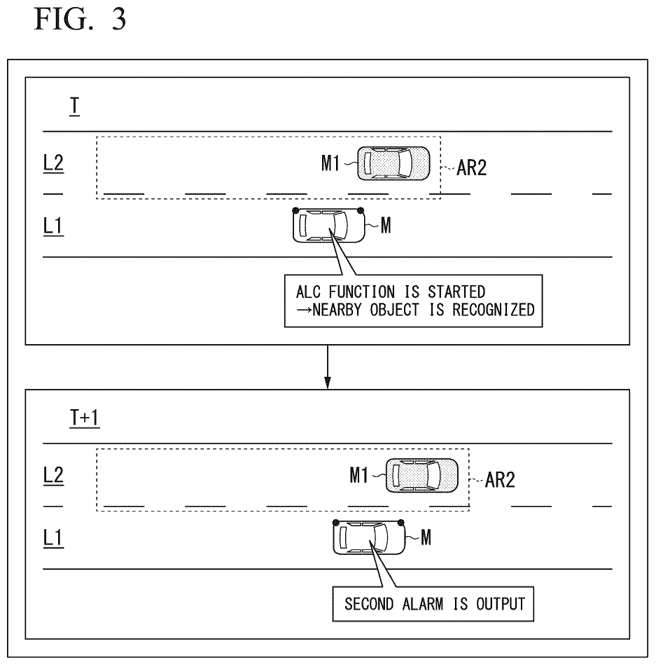

FIG. 3 is a diagram showing a second process of the second controller 154. At time T, the vehicle M is traveling in the first lane L1 and the vehicle MI is traveling in the second lane L2. When the driver performs a predetermined operation on the turn signal 90, the second controller 154 starts an automatic lane change (ALC) function. When the automatic lane change function (ALC function) starts, the second controller 154 outputs a second alarm indicating that automatic lane change is not possible to the driver when the vehicle M1 is present in a second area AR2 on the basis of the recognition result of the recognizer 110. Outputting of the second alarm may be performed using an image, speech, or the like or may be performed by causing a safety belt, a steering wheel, or the like to vibrate.

The second area AR2 is, for example, an area on a lateral side of the vehicle M and on a front side and a rear side in the traveling direction of the vehicle M in the second lane L2. The second area AR2 includes a position at a predetermined distance in front of the vehicle M in the traveling direction. The second area AR2 may be an area in which a length in the traveling direction varies according to a vehicle speed or a speed of another vehicle traveling in the second lane L2. For example, as the speed of another vehicle becomes higher, the length in the traveling direction of the second area AR2 is set to be longer. The first area AR1 is an area which is set to the lateral side of the vehicle M and the rear side in the traveling direction of the vehicle M in the second lane L2, and the second area AR2 is an area which is also set to the front side in the traveling direction of the vehicle M in the second lane L2.

At time T+1, when another vehicle is present in the second area AR2, the second controller 154 outputs an alarm indicating that automatic lane change is not possible to the driver of the vehicle M. When another vehicle is not present in the second area AR2, the second controller 154 determines that the vehicle M can change the lane to the second lane L2 without interfering with another vehicle and causes the vehicle M to perform automatic lane change.

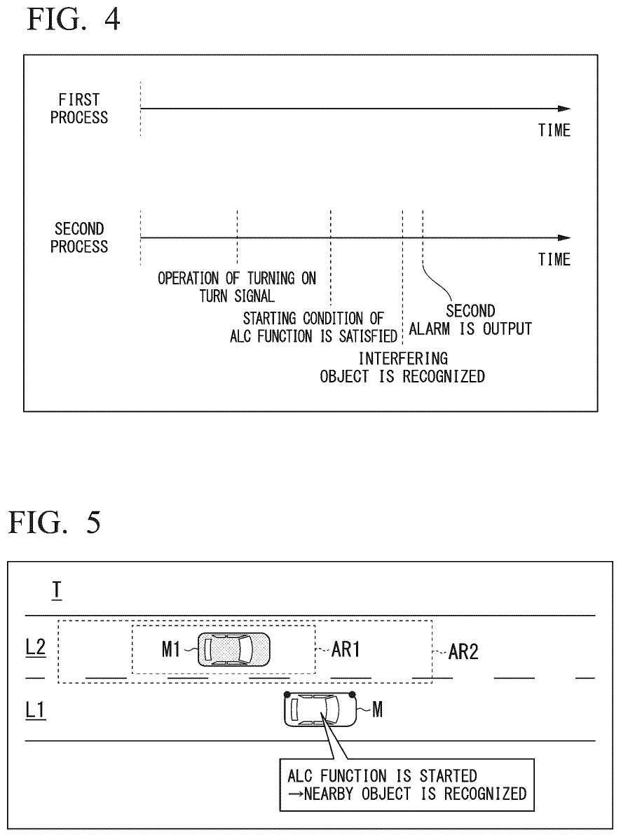

FIG. 4 is a timing chart of the second process. In FIG. 4, the process in the example of FIG. 3 is shown. In FIG. 4, since another vehicle M1 is not present in the first area AR1 but is present in the second area AR2, the first process is not performed and the second process is performed. When the driver performs an operation of turning on the turn signal 90, a starting condition of the ALC function is satisfied. The second controller 154 recognizes another vehicle interfering with automatic lane change on the basis of the recognition result of the recognizer 110. When there is another vehicle interfering with automatic lane change, the second controller 154 outputs the second alarm. As described above, when another vehicle M1 is not present in the first area AR1, the first alarm is not output, but the second alarm is output. The second alarm is an alarm which is output when it is determined that automatic lane change is not possible after a predetermined time elapses after the occupant has performed the operation (for example, an operation of turning on the turn signal 90).

### Comparison Between Comparative Example and Embodiment

On the other hand, when another vehicle M1 is present in the first area AR1 and the second area AR2 as shown in FIG. 5, the first alarm and the second alarm are output in a comparative example. Accordingly, an occupant of the vehicle M may feel inconvenience.

In the present embodiment, as will be described below, the controller 150 curbs outputting of the other alarm or outputs an alarm which is different from the type of one alarm when one of the first alarm and the second alarm is output and a condition in which the other alarm other than the one alarm is output is satisfied in response to an operation.

The operations which serve as a trigger of the first alarm and the second alarm and which are performed by the occupant of the vehicle M are operations on the same operator. This operator is, for example, an operator (for example, a turn signal lever switch) for turning on the turn signal. These operations may not be operations on the same operator, but may be operations on different operators. The operators may be buttons or buttons displayed on a display. When the operators are the same operator, the triggers of the first alarm and the second alarm are the same operator. However, when the operators are different operators, the operator serving as the trigger of the first alarm is a first operator (for example, the turn signal lever switch), and the operator serving as the trigger of the second alarm is a second operator (a button for starting automatic lane change).

The operation which serves as the trigger of the second alarm and which is performed by the occupant of the vehicle M may be the same as the operation serving as the trigger of the first alarm or may be an operation different therefrom. The operation which serves as the trigger of the second alarm and which is performed by the occupant of the vehicle M may be an operation which is performed successively to the operation which serves as the trigger of the first alarm and which is performed by the occupant of the vehicle M. The controller 150 outputs the first alarm in response to a first operation when the first operation is performed and a second operation is performed successively to the first operation and curbs outputting of the second alarm when it is determined that lane change is not possible in response to the second operation performed successively to the first operation.

The first operation is, for example, an operation of operating the turn signal lever switch by a predetermined degree in a direction in which the vehicle M is to change the lane (an operation of operating the turn signal lever switch to a position at which the turn signal 90 is turned on), and the second operation is, for example, an operation of maintaining the operation by the predetermined degree for a predetermined time (an operation of maintaining a half-pushed state). The second operation successive to the first operation may be an operation of further operating the turn signal lever switch in the same direction successively to the first operation.

Curbing outputting of an alarm may be prohibiting outputting of the other alarm or may be reducing an output degree of the other alarm to the occupant of the vehicle M more than the one alarm. Reducing the output degree of an alarm means, for example, that a sound volume is smaller than that of the one alarm or that display of an image is more simplified than that of the one alarm. Different types of alarms mean, for example, that the second alarm is a type of alarm different from that of the first alarm such as turning on an indicator or sound different from that of the first alarm when the first alarm is sound.

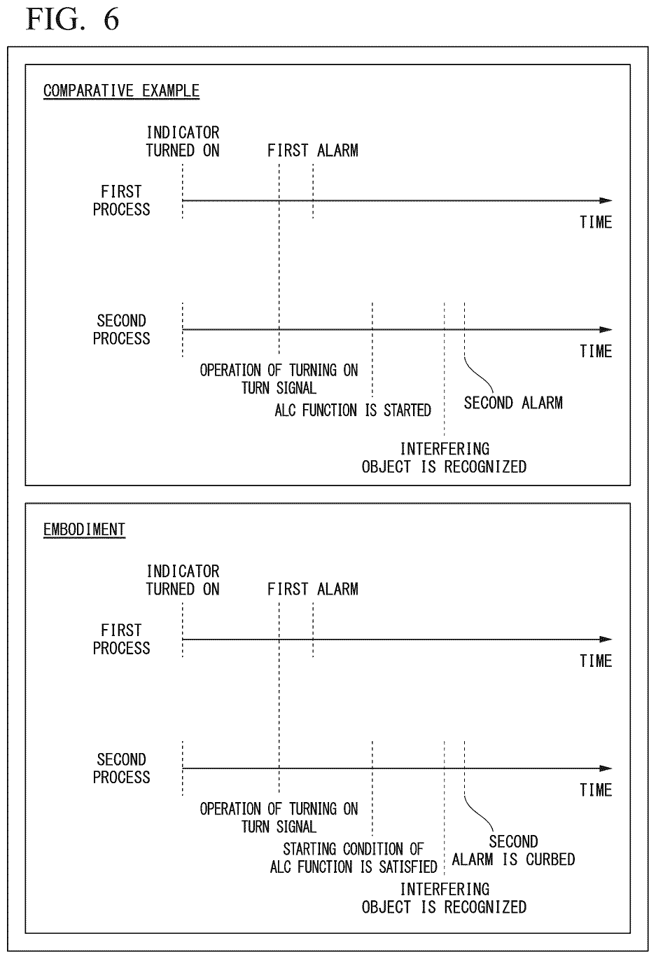

FIG. 6 is a diagram showing a timing chart of the process according to the comparative example and a timing chart of the process according to the present embodiment. FIG. 6 shows the timing charts of the processes in the situations shown in FIG. 5. In the comparative example, an indicator is turned on due to the presence of another vehicle M1. When the driver performs an operation of turning on the turn signal 90, the first alarm is output, and then the ALC function starts. When the presence of an object interfering with a lane change destination is recognized after the ALC function has started, the second alarm is output. In this way, in the comparative example, alarms of different functions are output, and thus the driver may feel inconvenience.

In the present embodiment, the indicator is turned on due to the presence of another vehicle M1. When the driver performs the operation of turning on the turn signal 90, the first alarm is output, and then the ALC function starts. Even when the presence of an object interfering with a lane change destination is recognized after the ALC function has started, the second controller 154 curbs outputting of the second alarm. In this way, in the present embodiment, outputting of alarms of different functions is curbed, and thus the driver's feeling inconvenience is curbed.

An example in which outputting of the second alarm is curbed has been described above, but when the second alarm (one alarm) is first output, outputting of the first alarm (the other alarm) may be curbed. For example, when another vehicle M1 is not present in the first area AR1 but is present in the second area AR2, the second controller 154 outputs the second alarm. When another vehicle M1 is present in the first area AR1 immediately thereafter and the turn signal 90 is operated, the first controller 152 may curb outputting of the first alarm.

### Flowchart (First Process)

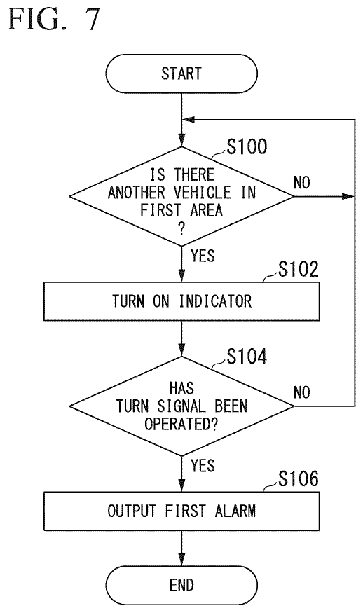

FIG. 7 is a flowchart showing a process flow that is performed by the first controller 152. First, the first controller 152 determines whether another vehicle is present in the first area AR1 (Step S100). When another vehicle is present in the first area AR1, the first controller 152 turns on the indicator (Step S102). Then, the first controller 152 determines whether the turn signal 90 has been operated (Step S104). When the turn signal 90 has not been operated, the process flow returns to Step S100. When the turn signal 90 has been operated, the first controller 152 outputs the first alarm (Step S106). In this way, this routine of the flowchart ends.

### Flowchart (Second Process)

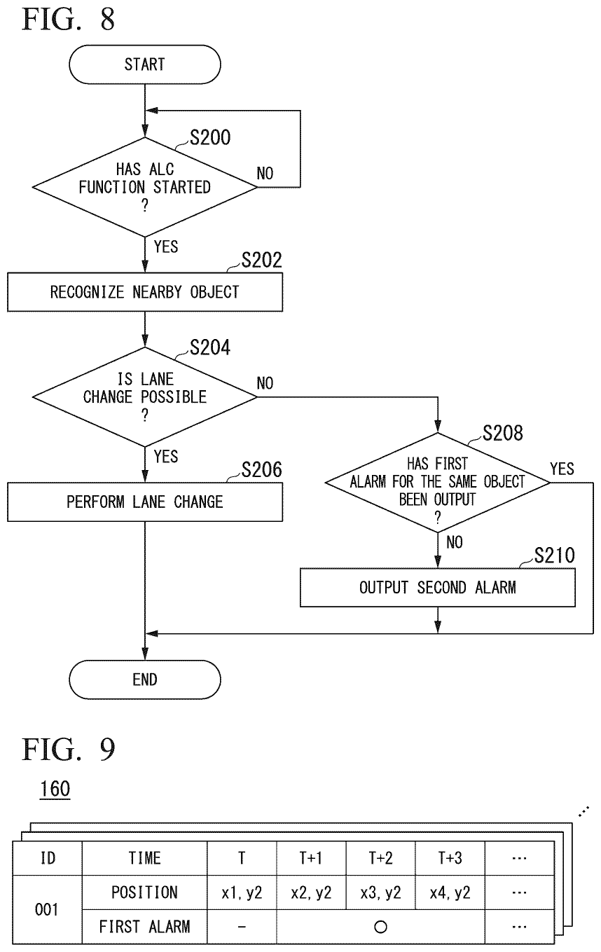

FIG. 8 is a flowchart showing a process flow that is performed by the first controller 152. The second controller 154 determines whether the ALC function has started (Step S200). When the ALC function starts, the second controller 154 recognizes a nearby object on the basis of the recognition result of the recognizer 110 (Step S202). Then, the second controller 154 determines whether there is another vehicle M1 interfering with lane change (Step S204). When there is not another vehicle M1 interfering with lane change, the second controller 154 changes the lane of the vehicle M by performing lane change (Step S206).

When it is determined in Step S204 that lane change is not possible, the second controller 154 determines whether outputting of the first alarm for the same object has been performed (Step S208). The second controller 154 performs the process of Step S208 with reference to reference information shown in FIG. 9 which will be described later.

When outputting of the first alarm for the same object is performed, the second controller 154 does not output the second alarm for the object. When outputting of the first alarm for the same object is not performed, the second controller 154 outputs the second alarm for the object (Step S210). When one alarm for a first object which is the object is output and a condition in which the other alarm for the first object is output is satisfied, the second controller 154 curbs outputting of the other alarm. When one alarm for a first object which is the object is output and a condition in which the other alarm for a second object other than the first object which is the object is output is satisfied, the second controller 154 does not curb outputting of the other alarm and outputs an alarm. In this way, this routine of the flowchart ends.

FIG. 9 is a diagram showing an example of reference information 160. The reference information 160 is information in which identification information of another vehicle, a position of the other vehicle every time, and whether to output the first alarm are correlated. When the first alarm for another vehicle “001” is output at time T, the first controller 152 correlates information indicating that the first alarm has been output with a corresponding record in the reference information 160. The second controller 154 can determine whether the first alarm has been output for the host vehicle M with reference to the reference information 160. Information indicating that the first alarm has been output in the reference information 160 is deleted when a predetermined time elapses after this information has been correlated in the reference information 160. Accordingly, the second controller 154 does not curb outputting of the second alarm before a predetermined time elapses after the first alarm has been output.

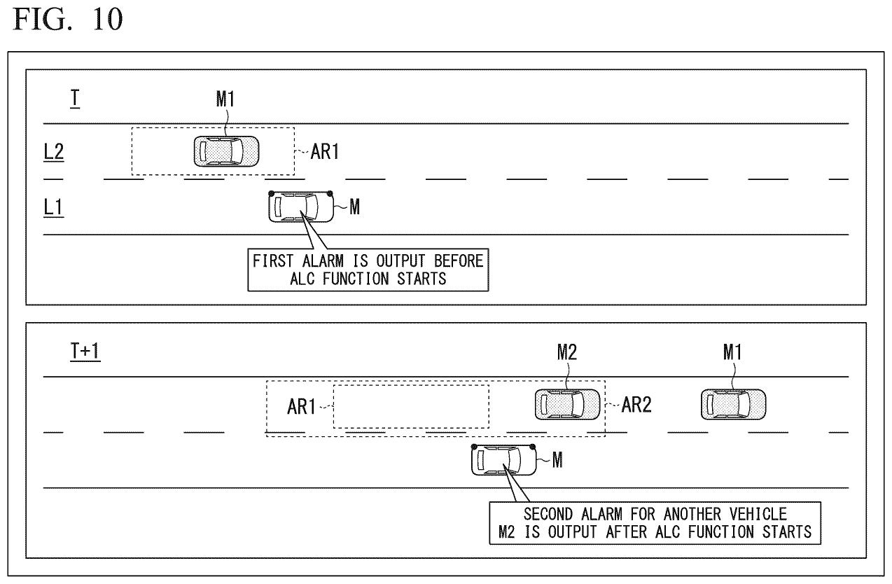

FIG. 10 is a diagram showing a situation in which outputting of the second alarm is curbed. At time T, the first controller 152 outputs the first alarm for another vehicle M1 before the ALC function starts when the driver has turned on the turn signal 90. At time T+2, the other vehicle M1 moves forward in front of the vehicle M and exits the first area AR1 and the second area AR2, and another vehicle M2 behind the other vehicle M1 enters the second area AR2. In this state, the ALC function starts. In this case, the second controller 154 does not output the first alarm for the other vehicle M2 and thus outputs the second alarm for the other vehicle M2.

An example in which another vehicle overtakes the vehicle M has been described above, but when the vehicle M overtakes another vehicle for which the first alarm has been output and then the second alarm for still another vehicle is to be output, the controller 150 does not curb outputting of the second alarm for the other vehicle instead thereof (in addition thereto).

As described above, the controller 150 determines whether the second alarm for another vehicle is to be output according to whether the first alarm for the other vehicle has been output and outputs the second alarm or curbs outputting of the second alarm. Accordingly, it is possible to output an alarm appropriate for the occupant of the mobile object.

The second controller 154 may output the first alarm in response to an operation performed by the occupant, start automatic lane change control for automatically changing the lane of the vehicle M to the second lane in which there is an object, curb outputting of the second alarm when it is determined that lane change is not possible, and then output the second alarm when automatic lane change control starts again in response to an operation performed by the occupant within a predetermined time from the previous operation. In this case, outputting of the first alarm in the second time or subsequent thereto may be omitted or curbed. Accordingly, when the driver of the vehicle M has performed the lane change operation a plurality of times, the driver is not highly likely to recognize another mobile object, and thus the second alarm is output. As a result, it is possible to allow the driver of the vehicle M to more reliably recognize the other vehicle.

When a predetermined time elapses or the vehicle M moves by a predetermined distance after one of the first alarm and the second alarm has been output and a condition in which the other alarm other than the one alarm is output is satisfied, the controller 150 may output the other alarm. Accordingly, it is possible to output an appropriate alarm when a predetermined time elapses or the vehicle M moves by a predetermined distance after the one alarm has been output and thus situations of the vehicle M and the other vehicle change. For example, it is assumed that the controller 150 outputs the first alarm, monitors surrounding conditions, and waits until it is time to perform automatic lane change. At this time, when a predetermined time elapses after the first alarm has been output or the vehicle M moves by a predetermined distance after the first alarm has been output and another vehicle for which the first alarm is to be output is present in the second area AR2, the controller 150 outputs the second alarm for the other vehicle. In this way, when a predetermined time elapses after the first alarm has been output or the vehicle M moves by a predetermined distance after the first alarm has been output, the controller 150 can allow the occupant to reliably recognize the presence of the other vehicle by outputting the second alarm.

According to the aforementioned embodiment, the controller 150 can output an alarm appropriate for the occupant (for example, the driver) of the vehicle M by curbing outputting of the other alarm when one of the first alarm and the second alarm is output and a condition in which the other alarm is output is satisfied.

The above-mentioned embodiment can also be expressed as follows:

A control device including:
a storage device storing a program; and
a hardware processor,
wherein the hardware processor executes the program stored in the storage device to perform:
   recognizing an object which is present in a second lane adjacent to a first lane in which a mobile object is traveling and which is present near the mobile object;
   outputting a first alarm when it is estimated that the mobile object is to move to the second lane in which the object is present in response to an operation performed by an occupant of the mobile object;
   starting automatic lane change control for automatically changing a lane of the mobile object to the second lane in which the object is present in response to an operation performed by an occupant of the mobile object;
   automatically changing the lane of the mobile object to the second lane when it is determined that the lane change is possible;
   outputting a second alarm for notifying the occupant that the mobile object is not able to automatically change the lane to the second lane when it is determined that the lane change is not possible; and
   curbing outputting of the other alarm when one alarm of the first alarm and the second alarm is output and a condition in which the other alarm is to be output is satisfied.

While exemplary embodiments of the present invention have been described above, the present invention is not limited to the embodiments and can have various modifications and substitutions applied thereto without departing from the gist of the present invention.

What is claimed is:

1. A control device comprising:
a storage medium storing computer-readable instructions; and
one or more processors connected to the storage medium,
wherein the one or more processors execute the computer-readable instructions to perform:
recognizing an object which is present in a second lane adjacent to a first lane in which a mobile object is traveling and which is present near the mobile object;
outputting a first alarm when it is estimated that the mobile object is to move to the second lane in which the object is present in response to an operation performed by an occupant of the mobile object;
starting automatic lane change control for automatically changing a lane of the mobile object to the second lane in which the object is present in response to an operation performed by an occupant of the mobile object;
automatically changing the lane of the mobile object to the second lane when it is determined that the lane change is possible;
outputting a second alarm for notifying the occupant that the mobile object is not able to automatically change the lane to the second lane when it is determined that the lane change is not possible; and
curbing outputting of the other alarm when one alarm of the first alarm and the second alarm is output and a condition in which the other alarm is to be output is satisfied.

2. The control device according to claim 1, wherein the one or more processors execute the computer-readable instructions to perform curbing outputting of the other alarm when the one alarm is output for a first object which is the object and a condition in which the other alarm for the first object is to be output is satisfied.

3. The control device according to claim 1, wherein the one or more processors execute the computer-readable instructions to perform not curbing the other alarm when the one alarm is output for a first object which is the object and a condition in which the other alarm for a second object other than the first object is to be output is satisfied.

4. The control device according to claim 1, wherein the first alarm is output when the occupant has performed an operation, and
wherein the second alarm is output when it is determined that the automatic lane change is not possible when a predetermined time elapses after the occupant has performed the operation.

5. The control device according to claim 4, wherein the one or more processors execute the computer-readable instructions to perform:
outputting the first alarm in response to an operation performed by the occupant;
starting the automatic lane change control for automatically changing the lane of the mobile object to the second lane in which the object is present; and
curbing outputting of the second alarm when it is determined that the lane change is not possible and then outputting the second alarm again when the automatic lane change control is started in response to an operation performed by the occupant.

6. The control device according to claim 1, wherein the one or more processors execute the computer-readable instructions to perform outputting the other alarm when a condition in which the other alarm other than the one alarm is to be output is satisfied when a predetermined time elapses or the mobile object moves by a predetermined distance after the one of the first alarm and the second alarm has been output.

7. The control device according to claim 1, wherein operations which are performed by the occupant of the mobile object and which serve as a trigger of the first alarm and the second alarm are operations on the same operator.

8. The control device according to claim 7, wherein the operator is an operator for turning on a turn signal.

9. The control device according to claim 1, wherein the first alarm is an alarm for notifying of the presence of another mobile object which is present in a blind spot on a lateral side of the mobile object which the occupant of the mobile object has difficulty in seeing when the other mobile object is present in the blind spot and the occupant turns on a turn signal such that the lane is changed to a lane in which the other mobile object is traveling.

10. A control device comprising:
a storage medium storing computer-readable instructions; and
one or more processors connected to the storage medium,
wherein the one or more processors execute the computer-readable instructions to perform:
recognizing an object which is present in a second lane adjacent to a first lane in which a mobile object is traveling and which is present near the mobile object;
outputting a first alarm when it is estimated that the mobile object is to move to the second lane in which the object is present in response to a first operation performed on an operator by an occupant of the mobile object;
starting automatic lane change control for automatically changing a lane of the mobile object to the second lane in which the object is present in response to a second operation performed on the operator by an occupant of the mobile object;
automatically changing the lane of the mobile object to the second lane when it is determined that the lane change is possible;
outputting a second alarm for notifying the occupant that the mobile object is not able to automatically change the lane to the second lane when it is determined that the lane change is not possible; and
outputting the first alarm in response to the first operation when the first operation is performed and the second operation is performed successive to the first operation and curbing outputting of the second alarm when it is determined that the lane change is not possible in response to the second operation performed successive to the first operation.

11. A control method that is performed by a computer, the control method comprising:
recognizing an object which is present in a second lane adjacent to a first lane in which a mobile object is traveling and which is present near the mobile object;
outputting a first alarm when it is estimated that the mobile object is to move to the second lane in which the object is present in response to an operation performed by an occupant of the mobile object;
starting automatic lane change control for automatically changing a lane of the mobile object to the second lane in which the object is present in response to an operation performed by an occupant of the mobile object;
automatically changing the lane of the mobile object to the second lane when it is determined that the lane change is possible;
outputting a second alarm for notifying the occupant that the mobile object is not able to automatically change the lane to the second lane when it is determined that the lane change is not possible; and
curbing outputting of the other alarm when one alarm of the first alarm and the second alarm is output and a condition in which the other alarm is to be output is satisfied.
